(19) United States
(12) Patent Application Publication
(10) Pub. No.: US 2013/0268887 A1
(43) Pub. Date: Oct. 10, 2013

(54) DEVICE AND PROCESS FOR AUGMENTING AN ELECTRONIC MENU USING SOCIAL CONTEXT DATA

(71) Applicant: Adam ROUSSOS, Reston, VA (US)

(72) Inventor: Adam ROUSSOS, Reston, VA (US)

(21) Appl. No.: 13/856,466

(22) Filed: Apr. 4, 2013

Related U.S. Application Data
(60) Provisional application No. 61/620,145, filed on Apr. 4, 2012.

(51) Int. Cl. G06F 3/0482

(52) U.S. Cl. CPC G06F 3/0482
USPC 715/810

(57) ABSTRACT

A process to augment a restaurant menu displayed electronically to a user is disclosed. The process may be implemented over a network. The user belongs to a social media environment and has friends or other data pertaining to that environment. The process uses this data to select or highlight content given by those contacts for a menu item on the electronic menu presented to the user. An algorithm selects those reviews to provide the best information to the user.

### FIELD OF THE INVENTION

The present invention relates providing a menu via electronic display on a device or by a computer. More particularly, the present invention relates to providing augmenting items listed on the restaurant menu with additional data provided in a social context.

### BACKGROUND

Electronic menus, whether displayed on a computer screen, mobile device, kiosk, computing pad and the like, provide a consumer convenient information in an easy-to-use format. A consumer may select menu items on the screen with prices or descriptions without the need for paper or brochure menus. The menu may be updated as needed without reprints or memorization of daily specials. An electronic menu especially is convenient for take-out or delivery orders. The consumer does not need to call, be placed on hold and rely upon whoever answered the phone to make the order or get information. All the information and pricing is in front of the consumer.

Most restaurants, whether large or small, will move to electronic menus at some point. Take-out and delivery orders lend themselves to such a format. For example, one may download an application for their mobile device that lists menus for various restaurants and eating places within a specified radius of one's location. Menus are presented and items selected. One then may pay for the items upon delivery or pick-up.

Not everyone, however, is a knowledgeable consumer about every item on every menu. A consumer has no idea how good or bad a menu item may be aside from “reviews,” either by stars, ratings or previous consumers. The consumer has no idea who the reviewers are, or even if they have any tastes in common. Further, the reviews may be fluff pieces or skewed towards negative reviews. For example, one rarely leaves a review of an item that tasted good, but only when it tastes bad. Moreover, many consumers judge the restaurant as a whole based on ambience, service, location and other factors that have little or no relation to the actual item ordered. Thus, these reviews, though helpful, may not convey the appropriate information for display on an electronic menu.

Alternatively, an electronic menu should not be cluttered with many comments and reviews, or else the electronic menu would become too unwieldy. The food items would be lost in a vast array of ratings and comments. Further, comments may have little to no bearing on the item being ordered at that time, especially if the restaurant has different chefs or menu items depending on the time of day or year. One may base their ordering decisions on faulty or inaccurate information.

### SUMMARY OF THE INVENTION

The disclosed embodiments personalize a restaurant menu, preferably displayed on an electronic device such as a smartphone, electronic tablet and the like. The personalization is accomplished by augmenting the menu provided by the restaurant with reviews from the user's social circle at the item level. In other words, data provided by others is displayed along with the menu items according to the social media relationships of the user.

The electronic menu will display the menu items along with ratings or reviews specific to those items and specific to the user viewing the menu. Subtext will be shown for strong social connections to the user of friends that have purchased and rated the particular menu items. An algorithm may be executed to determine the best reviews to display based on the level of social influence to the user. This algorithm may adjust the scope of the data used to select content for display on the electronic menu.

Thus, an augmented menu is shown with the social context data selected by the algorithm. Not all ratings and information generated regarding the menu item are displayed. Only that information highlighted by the algorithm is displayed. This feature prevents cluttering of the electronic menu or needless information from being displayed. Moreover, each augmented menu is specific to the user and time of viewing, as social connections may change rapidly. The user received a personalized menu based on her social connections over a social media environment.

A method for augmenting an electronic menu displayed on an electronic device is disclosed. The method includes determining content relating to a menu item on the electronic menu. The method also includes accessing a social media network having a plurality of members. The method includes selecting a subset of the content relating to the menu item based on a relationship in the social media network between a user and the plurality of members. The method also includes augmenting information about the menu item with the subset of content for display with the electronic menu.

A method for augmenting an electronic menu with reviews for menu items also is disclosed. The method includes determining at least one menu item to display on an electronic device. The method also includes deriving content regarding the at least one menu item including a review provided by a previous customer. The method also includes associating the review with data from a social media network pertaining to the previous customer. The method also includes augmenting the at least one menu item displayed to a user with the review from the previous customer.

A device for displaying an augmented restaurant menu also is disclosed. The device includes a processor to execute instructions stored in a memory. The instructions control the device to receive at least one rating for a menu item on the menu. The instructions also control the device to harvest data from a social media network. The data is associated to a user of the electronic device. The instructions also control the device to receive the data from the social media network. The instructions also control the device to select content related to the menu item based on the data. The instructions also control the device to augment the menu with the content for the menu item for display to the user. The display may be a web-based display.

### BRIEF DESCRIPTION OF THE FIGURES

The accompanying drawings are included to provide further understanding of the invention. The below figures constitute a part of the specification. The drawings listed below illustrate embodiments of the present invention, and, together with the description, serve to explain the principles of the invention, as disclosed by the claims and their equivalents.

FIG. 1A illustrates a system for providing an augmented electronic menu according to the disclosed embodiments.

FIG. 1B illustrates another view of a system for providing information to augment an electronic menu according to the disclosed embodiments.

FIG. 2 illustrates a flowchart for augmenting an electronic menu with content according to the disclosed embodiments.

FIG. 3 illustrates a flowchart for determining a subset of content to augment an electronic menu using a social media network according to the disclosed embodiments.

FIG. 4 illustrates an augmented menu for display on an electronic device according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without departing from the spirit or scope of the claims. It should be noted that like elements recited below are indicated by like reference numbers in the accompanying figures.

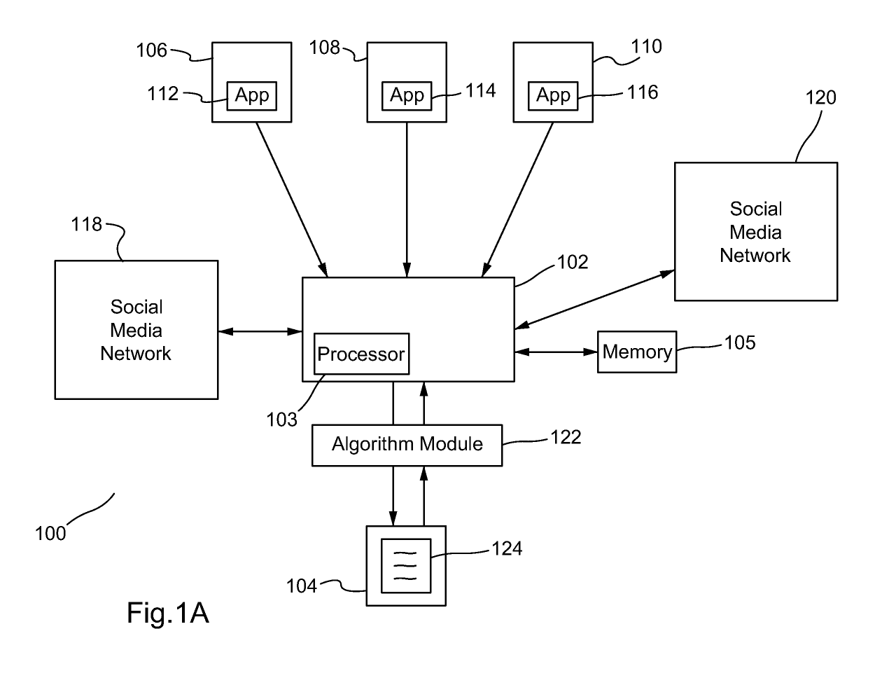

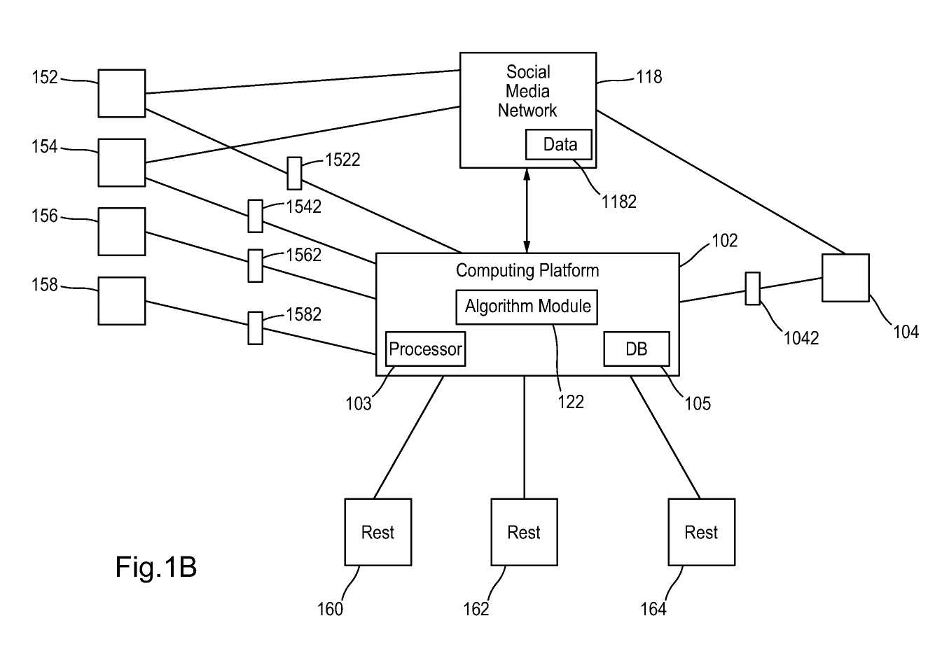

FIG. 1 depicts a system for providing an augmented electronic menu over a network 100 according to the disclosed embodiments. Network 100 may be a mobile network, local area network (such as in a restaurant), virtual private network and the like. Preferably, the components or devices within network 100 are IP-addressable in that they can be exchange data over the Internet. Network 100 may allow take-out or delivery food ordering from a restaurant. Alternatively, network 100 may be in the restaurant, cafeteria, office setting and the like where the user sits down and eats at that location. Preferably, devices connected to network 100 access the Internet and include a browser, application and the like that allows for the display of information on such devices.

Network 100 includes menu augmentation computing platform 102 that receives data and information from other devices and networks, and then executes an algorithm to select the social context content, or data, used to augment an electronic menu. The algorithm may be provided or updated from another location within network 100. The augmented menu is disclosed in greater detail below. Computing platform 102 includes processor 103 that executes instructions to implement the algorithm and to augment the electronic menu. Computing platform 102 also sends and receives data over network 100. A memory 105 stores data for retrieval by computing platform 102. Memory 105 also may be a database capable of storing large amount of data, or may be distributed memory platforms such that the data is accessible by computing platform 102 over network 100. Computing platform 102 may be hosted on a server, computer, or a combination of these.

Preferably, computing platform 102 is an application that provides electronic menus to devices connected in network 100. The menus are requested by users and the data associated with electronically displaying the menus is sent to the requesting device. Computing platform 102 may receive the requests and augment (amend) the electronic menu accordingly with additional content discernible from other users.

Content in the form of reviews, ratings and comments are received at computing platform 102 from devices 106, 108 and 110. A plurality of devices may be used in network 100, and the amount of data is not limited to that shown. Preferably, these devices are mobile or portable in nature, but also may be connected to network 100 via wire, such as a device at the table in the restaurant or a home computer connected to the Internet. Devices 106, 108 and 110 also may be used by customers of various restaurants.

As customers order and eat menu items, they may rate the items using their devices. Applications 112, 114 and 116 provide the user interfaces to input the data and connect to network 100. For example, the user of device 106 may rate a nacho platter at one restaurant, while the user of device 108 rates a bubba burger at the same restaurant. The user of device 110 may rate a piece of pie at another restaurant. Preferably, a large number of users will rate a huge variety of menu items so that a robust database of information is compiled for every menu item.

For example, a user comes into a restaurant called Burgers and More and interacts with device 104. Device 104 displays electronic menu 124. Device 104 may be any electronic device or screen. The user logs in or inputs her information into device 104. Device 104 then sends this information to computing platform 102. Based on this personal information, computing platform 102 interacts with one or more social media networks, or environments, to pull contacts, friend information or other social context relationships pertaining to the user. As shown in FIG. 1, social media environment 118 may include friends and friends of friends that center around a social network. Social media environment 120, however, may include business contacts and professional relationships that the user uses in their career. Computing platform 102 may use social context data from both environments to augment menu 124.

Once computing platform 102 pulls the social context data, it executes an algorithm using algorithm module 122 to determine which ratings or comments will be used to augment the electronic menu to the user on device 104. Algorithm module 122 may use factors identified by the user to determine appropriate content. After applying these factors, electronic menu 124 is augmented with the determined content, and displayed with it on device 104.

FIG. 1B depicts another view of a system 150 for providing information to augment an electronic menu according to the disclosed embodiments. System 150 may relate to network 100 above. Preferably, system 150 operates over a wireless network wherein mobile devices exchange information with each other and can access computing platforms for additional services. In other words, the devices may access information and data at other locations over the network. In this instance, the devices may access menus for food service providers of interest.

System 150 includes computing platform 102, as disclosed above. Computing platform 102 includes processor 103 and memory, or database, 105. Alternatively, computing platform 102 includes a plurality of memory locations 105, and may communicate with other locations within system 150 to store and retrieve data. Algorithm module 122 is shown as part of computing platform 102. The algorithm used by computing device 102 may be implemented by algorithm module 122. This algorithm may be updated by sending instructions to computing platform 102. The algorithm is disclosed in greater detail below.

Computing platform 102 may include specially-programmed, special-purpose hardware, such as an application-specific integrated circuit that includes processor 103. Aspects of the invention may be implemented in software, hardware or firmware, or any combination thereof. Further, such methods, functions, systems, elements, modules and components may be practiced on one or more computers having a different architecture or features.

System 150 includes device 104, as disclosed above. The user of device 104 may belong to social media network 118. Social media network 118 may be hosted on a plurality of computers and devices linked via the network's own applications. Social media network 118 includes data 1182. Data 1182 may be data pertaining to the user's account, such as contacts, likes, check-ins, and the like. Data 1182 also may include such information for a variety of users, wherein each user is assigned an account.

A plurality of devices 152, 154, 156 and 158 also are connected to computing platform 102 through system 150. Users of these devices may comment and provide content, such as ratings, on various menu items through computing platform 102. This is shown in greater detail below. For simplicity, the description below will deal with one menu item.

As shown in FIG. 1B, content 1522 regarding a menu item is provided from device 152, content 1542 regarding the menu item is provided from device 154, content 1562 is provided from device 156 and content 1582 is provided from device 158. Content may include a rating, such as 3 out of 5 stars, and a review, which may be a textual description, such as “great burger; lots of flavor!” Thus, computing platform 102, which hosts the application supporting the menus and their delivery to devices, receives content containing information about items on those menus. Preferably, the content is a review, such as a sentence about the item. Alternatively, the content may be a rating.

The content from each device may be accessible by restaurants 160, 162, and 164. A restaurant may flag negative comments or low ratings using algorithm module 122. The restaurant does not have to sift through all the comments, but only those that impact it or meets a certain criteria. Thus, a restaurant may see negative comments and react accordingly. A restaurant also may remove the comments once the issue has been resolved. Thus, negative or critical information is not sent to device 104.

An electronic menu, such as menu 124, may be provided to device 104 along with content 1042 selected by computing platform 102 and algorithm module 122. Not every piece of content received by computing platform 102 is provided to device 104. Doing so would clutter the display of menu 124, as well as provided potential negative comments/ratings from people not sharing the same interests as the user of device 104. Thus, computing platform 102 pares down the amount of content to display on device 104.

According to the disclosed embodiments, computing platform 102 accesses social media network 118 to retrieve data 1182 about the user of device 104 without requiring the user to log into social media network 118. Using data 1182, computing platform 102 may execute the algorithm in algorithm module 122 to select or identify a subset of all the content received on a menu item. For example, data 1182 may include close contacts indicated by the user as good friends that share common values or tastes. The user may set this parameter when signing up for the application on computing platform 102. Other parameters and factors also may be used.

Algorithm module 122 goes through the content and, using specified factors and data 1182, generates a subset of the content for at least one menu item of electronic menu 124. In other words, using the close contacts information provided by social media network 118, computing platform 102 selects that content provided by those contacts. This subset then forms the content used to augment the menu sent to device 104.

Referring to FIG. 1B, the users of devices 152 and 154 belong to social media network 118. The users of devices 156 and 158 do not belong to network 118. The user of device 104 also is registered with social media network 118. Device 104 requests an electronic menu 124 be sent for restaurant 160. Restaurant 160 provides the information for the menu to device 104 via computing platform 102.

Computing platform 102 receives the request and retrieves the information for the menu. It then accesses social media network 118 to retrieve data corresponding to device 104. For example, device 104 may have a telephone number or IP-address for an account of the user of network 118. The user may provide a password or account name as well. Using data 1182 from network 118, algorithm module 122 selects contents 1522 and 1542 to augment the menu sent to device 104. Contents 1562 and 1582 are not selected as devices 156 and 158 are not linked to social media network 118. Alternatively, the users of devices 156 and 158 may belong to social media network 118, but are not friends with the user of device 104.

Thus, the disclosed embodiments do not provide recommendations for restaurants, but, instead, filters content, such as comments and ratings, on items sold by the restaurant to provide better information to a user to make an informed decision. A user may search for restaurants or take-out locations using a search engine. Once a location is selected, a menu is augmented with the content using the disclosed embodiments.

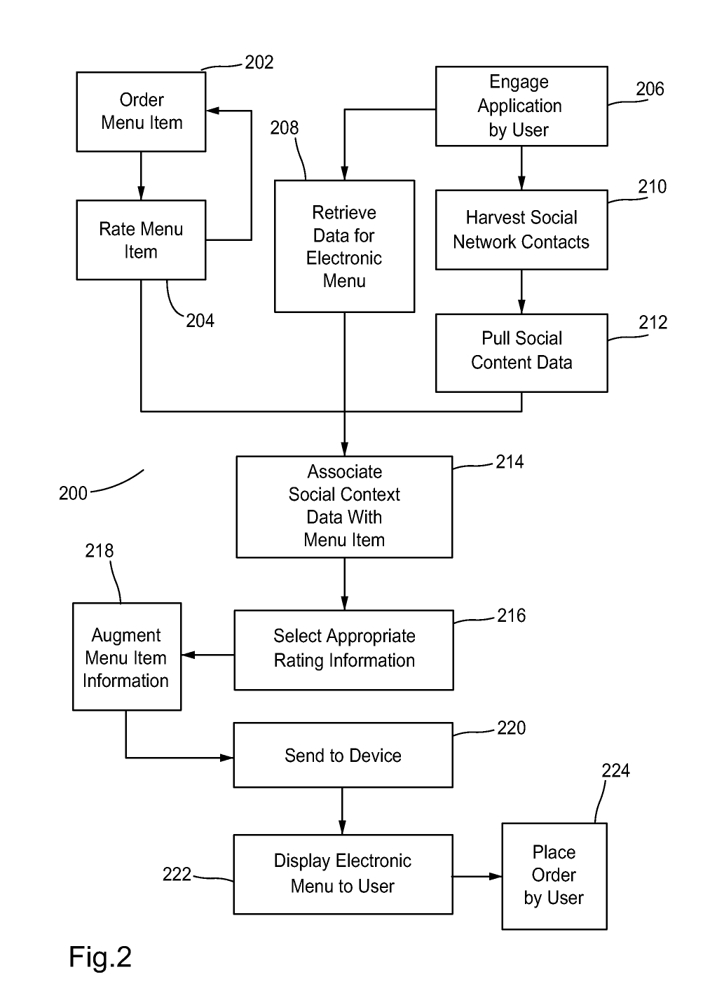

FIG. 2 depicts a flowchart 200 for augmenting an electronic menu according to the disclosed embodiments. The process disclosed by flowchart 200 may be implemented over network 100 or system 150, with the augmented menu, such as electronic menu 124, being displayed to the user.

Step 202 executes by a patron ordering a menu item from a restaurant or any eating establishment. The patron eats the menu item. Step 204 executes by the patron rating the menu item or providing a comment specific to the menu item. The result may be known as content, as disclosed above. The rating may occur due to a prompt or text from the restaurant to the user. For example, the patron may rate between 1 to 5 stars. Steps 202 and 204 are repeated as needed, and there is no limit on the number of menu items ordered and rated. Preferably, a large amount is generated for menu items for use by the disclosed processes to produce an aggregate rating along with a number of reviews. The content is sent over an electronic network.

Step 206 executes by a user engaging the augmented menu application to order food. This application may execute on a device, such as device 104. The application is stored on the device and launched, when desired, by the user. Step 208 executes by retrieving information and data for the electronic menu. Step 210 executes by harvesting social network contacts from the social media network. The user allows this data to be retrieved by the application in order to run the algorithm and disclosed processes. Preferably, this occurs as a web-based application. Step 212 executes by pulling in the social context data, such as friend lists, ranked relationship lists and the like, for the user. As disclosed below, this data may be expanded to include friend of friends, members in the same location or other parameter, such as employment, school, demographics, and the like.

Step 214 executes by associating the social context data with the menu items retrieved for the electronic menu. This step is disclosed in greater detail below. Step 216 executes by selecting appropriate rating information based on the social context data. Step 218 executes by augmenting the menu items within the electronic menu with the content determined by the social context data. Thus, a subset of the total amount of content for a particular item may be created using the disclosed embodiments. For example, if a menu item has 30 comments or reviews, the disclosed embodiments will select 2 or 3 to augment the menu for display to the user based upon the social media context data.

Step 220 executes by sending the electronic menu along with the menu items with the augmented content to the device of the user, such as device 104. Step 222 executes by displaying the menu items of the electronic menu to the user as augmented with the determined content for ratings and comments from the friends or other people based on relationships with the user. The display of the menu may occur using a web-based browser or page that is displayed on a device, computer screen, and the like. Preferably, the menu is displayed using webpage that is a web document or other web resource that is suitable for the World Wide Web and can be accessed through a web browser and displayed on a monitor or mobile device. This information is usually in HTML or XHTML format, and may provide navigation to other web pages via hypertext links. A webpage hosting the menu may be from a local computer or a remote web server.

The user is not just getting comments from anyone, but from those people that she knows or at least has some relationship with. The user may refer to the information as she wishes. The user observes the menu item with the augmented content, such as “great burger!” and notes it is from a well-known acquaintance. Step 224 executes by the user ordering at least one menu item from the electronic menu.

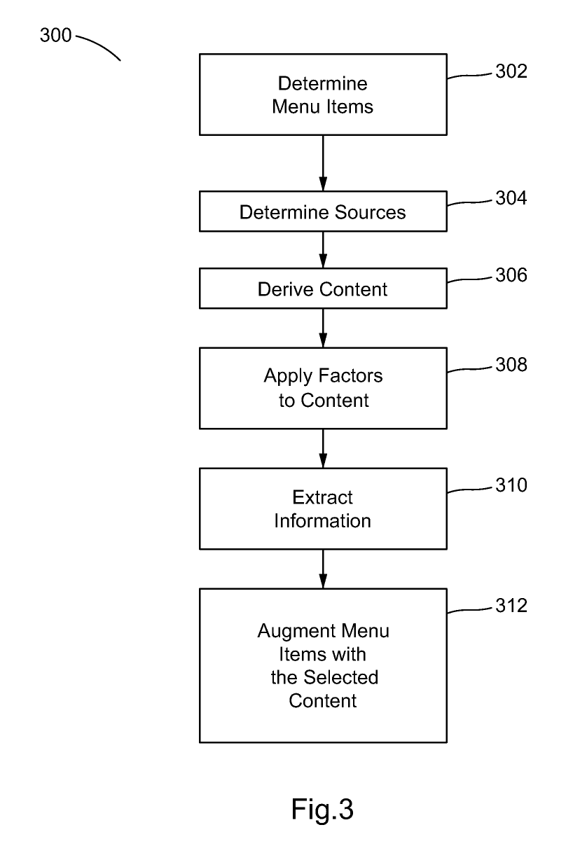

Additional steps may be included in flowchart 200. Further, step 202 and 204 may execute independently of the other steps. Steps 214-218 may be further expanded by FIG. 3 below. FIG. 3 depicts a flowchart 300 for determining content to augment an electronic menu according to the disclosed embodiments. Flowchart 300 may be associated with algorithm module 122 and the algorithm executed to select the content with which to augment a menu.

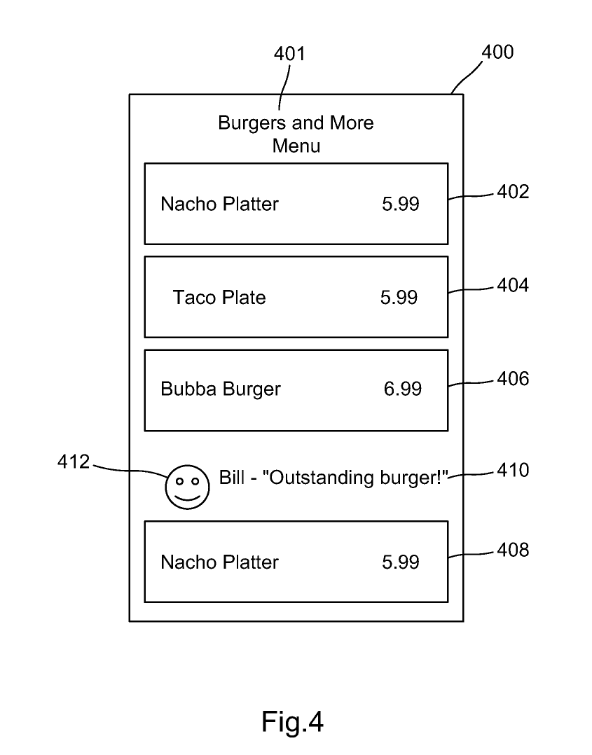

Step 302 executes by determining the menu items for display of a restaurant or eating establishment of choice. Not every menu item may be displayed. An example of the menu items is shown in FIG. 4. Menu items may include price and a short description.

Step 304 executes by determining sources for social context data. The disclosed embodiments may harvest social media environments, which makes available the data from those environments. Data may include friends, friends of friends, groups, pages, subscribers, and the like that have some sort of relationship with the user. The user may set limits on what social context data is available for this step. Further, the algorithm may expand the scope of the data as it executes to capture content applicable for display to the user.

Step 306 executes by deriving content from the sources. Content may include comments and reviews/ratings of a variety of menu items. Step 308 executes applying factors to the content using the social context data. Factors may include the restaurant's preferences, the nature of the connections to the user viewing the menu, items previously purchased, time or date that the review was made, a rating, distance from location, and the like. Other factors include whether the rating includes negative or critical words. Those ratings slamming a restaurant may be excluded.

Further, the algorithm used above may filter the reviews using ratings only having a certain value. In other words, negative ratings are not really appropriate as content for a menu item where the user only needs 2 or 3 comments. Thus, a rating may be defined as the aggregate number of stars, or any other designator, for a particular item. For example, 3.5 stars as rated by 10 patrons on a Burrito Supreme item by the Taco Palace may be the aggregate rating. A review may include a rating value along with text, such as “wow, the burrito was spicy and filling” by a social media connection.

The disclosed algorithm may only consider those reviews having a certain rating, such as above 3 out of 5 stars. Once those reviews below that threshold are filtered, then the algorithm may select content for display based on additional factors, such as date when review was left, time of day, age similarities, and the like. This threshold is important as restaurants want positive feedback made available to customers. Restaurants most likely will not participate in this process if negative information is augmented to the electronic menu. Thus, the disclosed embodiments select those comments that a dining establishment feels comfortable being made public. Negative reviews and low ratings, however, may be identified by the disclosed algorithm and provided to the restaurants to address customer issues, as disclosed in greater detail below.

To illustrate, the user of the disclosed application goes into a restaurant that a friend or contact has visited and eaten at. A positive review of a menu item has been left by the friend, and, thus, this review will be shown to the user. Preferably, this is the only review shown to the user as the review meets the rating criteria and has been left by a contact. Other aggregate ratings may be shown, such as an average of stars, but the disclosed algorithm will not show every review associated with the ratings.

The importance of this feature is that while the user can receive a multitude of reviews for restaurants and their menus, the disclosed embodiments only show reviews of interest that are selected based on the social network data and contacts, and limits the display of reviews to only those believed to have a high level of importance. In yet another embodiment, this step may select one review to show on the menu in order to cut down on screen/menu clutter. The algorithm may select the review having the highest rating, and closest relationship with the user. If there are several reviews meeting this criteria, then the most recent review may be selected.

The disclosed algorithm also may adjust the scope of the social media data to identify reviews that may have a looser connection with the user. In other words, the user would like to have some information as opposed to no information. In the event that the user does not have a contact applicable to the menu or listed items, then this step may identify a lesser connection within the social network and display that review. For example, the order of importance placed by the algorithm may be friends, friends of friends, members having the same identified interests, or “likes,” members of the same group (professional, social, interest), the same employment or school, same locality, and the like.

Thus, this step may execute the algorithm as disclosed above. If no reviews are available, the algorithm may rerun using the different parameters, each time expanding the scope of the data available. The user may limit this scope. A temporal component also may be added to the algorithm. The disclosed embodiments may consider reviews for the past month, then six months and so on. The more recent reviews may be more applicable for selection.

Reviews not selected by the disclosed embodiments may be routed to the restaurant for their own use. In other words, negative reviews or low ratings may be used by the dining establishment to improve customer relations. The reviews are not made public so as not to embarrass the restaurant, but could serve as a tool to address issues impacting certain segments of customers. Thus, a restaurant may receive copies of ratings and reviews not delivered to the user when the disclosed process is run. The user is not aware of this information.

Further, the disclosed embodiments may include deferred reviews so that a restaurant may process the reviews before any ratings impact the aggregate rating for the menu item. In other words, the restaurant may address those reviews/ratings that lower their score to take care of any issues. For example, a patron gives a 2 star review for an item, such as onion rings. The restaurant would have the option to respond to the patron's concern by giving a coupon or a credit, discuss the issues, and so forth. If the aggregate rating for the onion rings is 3.5, then this process allows the restaurant to keep that rating.

Step 310 executes by extracting information or content to use for the menu to the user, if needed. This is the reviews and/or ratings selected by the disclosed algorithm. Step 312 executes by augmenting the menu items shown to the user with the determined content. Thus, only those ratings and comments that should be important to the user are shown.

For example, an augmented menu will be displayed with certain menu items subtexted or otherwise noted with a review or rating from a community or friends of the user from one or more social networks for that specific item. Thus, if Adam in Reston goes to a restaurant in Chicago, he may see where his friend Chris from Seattle tried and liked a menu item at the restaurant. Chris is Adam's close acquaintance on a leading social media network. Joe also knows Adam but is not friends with him on the network, so his review of the menu item is excluded.

FIG. 4 depicts an augmented menu 400 for display according to the disclosed embodiments. Menu 400 may relate to menu 124 disclosed above. Menu 400 includes menu items 402, 404, 406 and 408. Using another example, Bill may use this menu to purchase a Bubba Burger, shown as menu item 406. Bill rates the menu item back to the restaurant, and this is made available to computing platform 102, or stored in a database of the restaurant. Bill makes a review of the item, or Bubba Burger, by inputting text associated with the item. Preferably, Bill gives a “positive” rating and review.

Charlie then enters the restaurant and is given a tablet to order from menu 400. Charlie is friends with Bill on a business networking environment. Menu 400 is augmented with Bill's comment on the Bubba Burger so that Charlie can take into account his contact's opinion when ordering. Thus, Charlie is provided a more valuable recommendation than typical ratings and comments from people unknown or unimportant to Charlie.

Further, the disclosed algorithm selects a review having a positive rating for display. As shown, Charlie realizes that Bill liked the Bubba Burger, and that he may like it as well. Other patrons also may provide reviews of the Bubba Burger, but those reviews are not shown because these patrons are not friends or affiliated with Charlie via a social media network. The data pulled by the disclosed embodiments did not identify these patrons as having a relationship with Charlie. Alternatively, the reviews provided by those patrons having a relationship may be negative or not meeting the threshold rating for display. Those reviews only giving 1 or 2 stars out of 5 are not selected. As disclosed above, these “low” ratings may be used by participating restaurants to address customer concerns before such reviews become public.

Thus, disclosed system allows existing electronic menu displays to include content filtered or selected according to social media data. Unlike conventional processes that recommend a restaurant based on social media, the disclosed embodiments harvests the data provided by the social media network to then determine what content to provide to the user for a better dining experience. The application provides information to the user based on the disclosed algorithm and processes along with the data provided by the social media network.

The disclosed embodiments may be supported and executed on a platform that has access to a network. The platform may support software and executable programs to provide the functionality disclosed above. For instance, the software may be deployed. Any software embodying the similar event algorithm and its processes may be deployed by manually loading directly to the client, server and proxy computers via loading a storage medium such a CD, DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more computer systems coupled to a network capable of exchanging information and data. These computer systems also may be general-purpose computer systems. Various functions and components of the computer system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications and variations can be made in the disclosed devices and processes without departing from the spirit or scope of the invention. Thus, it is intended that the present invention covers the modifications and variations of the embodiments disclosed above provided that the modifications and variations come within the scope of the claims and their equivalents.

1. A method for augmenting an electronic menu displayed on an electronic device, the method comprising:
determining content relating to a menu item on the electronic menu;
accessing a social media network having a plurality of members;
selecting a subset of the content relating to the menu item based on a relationship in the social media network between a user and the plurality of members; and
augmenting information about the menu item with the subset of content for display with the electronic menu.

2. The method of claim 1, further comprising requesting the menu item for display on the electronic device.

3. The method of claim 1, wherein the selecting includes executing an algorithm to select the subset of content.

4. The method of claim 3, wherein the executing includes determining a review pertaining to each content of the subset.

5. The method of claim 4, wherein the executing also includes selecting content having a specified review to be included in the subset.

6. The method of claim 1, wherein the selecting includes selecting the subset of content according to at least one factor.

7. The method of claim 1, further comprising excluding content from display if no relationship exists between the user and the social media network.

8. The method of claim 1, wherein the electronic device is a wireless electronic device.

9. The method of claim 1, wherein the content includes a rating of the menu item.

10. A method for augmenting an electronic menu with reviews for menu items, the method comprising:
determining at least one menu item to display on an electronic device;
deriving content regarding the at least one menu item including a review provided by a previous customer;
associating the review with data from a social media network pertaining to the previous customer; and
augmenting the at least one menu item displayed to a user with the review from the previous customer.

11. The method of claim 10, wherein the associating includes identifying the previous customer as having the relationship with the user through the social media network.

12. The method of claim 10, further comprising executing an algorithm on the content to select the review provided by the previous customer.

13. The method of claim 12, wherein the executing the algorithm includes applying a factor to the content.

14. The method of claim 12, wherein the executing includes determining the review pertaining to each content of the subset.

15. The method of claim 14, wherein the executing includes selecting content for the subset according to the review.

16. The method of claim 12, wherein the executing includes determining an appropriate amount of the data from the social media network.

17. The method of claim 10, further comprising harvesting the data from the social media network.

18. The method of claim 10, further comprising displaying the at least one menu item using a web-based display.

19. The method of claim 10, further comprising displaying the at least one menu item using a webpage.

20. A device for displaying an augmented restaurant menu, the device comprising:
a processor to execute instructions stored in a memory, wherein the instructions control the device to
receive at least one rating for a menu item on the menu;
harvest data from a social media network, wherein the data is associated to a user of the electronic device;
receive the data from the social media network;
select content related to the menu item based on the data; and
augment the menu with the content for the menu item for display to the user.
